(19) United States
(12) Patent Application Publication
(10) Pub. No.: US 2026/0215505 A1
(43) Pub. Date: Jul. 30, 2026

(54) VAPORIZING CORE, INJECTION MOLD FOR VAPORIZING CORE, INJECTION MOLDING METHOD AND ELECTRONIC CIGARETTE

(71) Applicant: SHENZHEN GEEKVAPE TECHNOLOGY CO., LTD., Shenzhen, Guangdong (CN)

(72) Inventors: Wenbin Niu, Shenzhen, Guangdong (CN); Jiadong Zang, Shenzhen, Guangdong (CN); Weijun Chen, Shenzhen, Guangdong (CN); Qinyao Xu, Shenzhen, Guangdong (CN)

(21) Appl. No.: 19/145,195

(22) PCT Filed: Aug. 16, 2024
(86) PCT No.: PCT/CN2024/112646

§ 371 Date: Jul. 1, 2025

(30) Foreign Application Priority Data
Aug. 18, 2023 (CN) 202311050500.1
Aug. 18, 2023 (CN) 202322239291.7
Aug. 18, 2023 (CN) 202322241482.7
Aug. 18, 2023 (CN) 202322242233.X

(51) Int. Cl. A24F 40/46; A24F 40/10; A24F 40/70; B28B 1/24; H05B 3/06

(52) U.S. Cl. CPC A24F 40/46; A24F 40/10; A24F 40/70; B28B 1/24; H05B 3/06

(57) ABSTRACT

A vaporizing core, an injection mold for a vaporizing core, an injection molding method, and an electronic cigarette. The vaporizing core comprises a porous body (310) and a heating mesh (331), the porous body (310) is provided with a vaporizing chamber (330) having a square chamber structure, the heating mesh (331) is embedded in an inner wall of the vaporizing chamber (330), and an end of the porous body (310) near a vapor outlet is provided with a ring-shaped vapor duct structure (320). Compared with the traditional ring-shaped ceramic vaporizing core, an area of the internal heating mesh area is enlarged, and a vapor output is increased.

The present application claims priority to the following Chinese patent applications, and the content of all of these patent applications is incorporated herein by reference in its entirety:
1. the Chinese Patent Application No. 202311050500.1, filed on Aug. 18, 2023, titled Hot-pressing Injection Mold, Injection Molding Method Therefor and Use Thereof;
2. the Chinese Patent Application No. 202322239291.7, filed on Aug. 18, 2023, titled Bending Jig and Heating Mesh;
3. the Chinese Patent Application No. 202322241482.7, filed on Aug. 18, 2023, titled Heating Mesh, Vaporizing Core, and Vaporizing Device; and
4. the Chinese Patent Application No. 202322242233.X, filed on Aug. 18, 2023, titled Porous Vaporizing Core Structure, Vaporizing Device, and Electronic Cigarette.

### TECHNICAL FIELD

The present disclosure relates to the technical field of vaporization technology, in particular to a vaporizing core, an injection mold for a vaporizing core, an injection molding method and an electronic cigarette.

### BACKGROUND ART

As a critical component of the electronic cigarette, a vaporizing core directly affects vapor output, flavor quality, service life, and other performance attributes of the electronic cigarette. At present, there are two main types of vaporizing cores on the market: cotton vaporizing cores and ceramic vaporizing cores. Cotton vaporizing cores have become the mainstream choice due to their excellent vaporization performance. However, they also suffer from many problems. For example, a manufacturing process of cotton vaporizing cores usually requires manual winding and wrapping of cotton, resulting in low production efficiency and consistent product quality. In addition, cotton vaporizing cores are prone to scorching during the vaporization process, and organic particles released during scorching may enter the lungs and pose health risks. The burnt odor will irritate the throat and cause discomfort. Moreover, the service life of cotton vaporizing cores is relatively short.

Ceramic vaporizing cores are gradually replacing the cotton vaporizing cores and become the primary heating element of the next generation due to their longer service life, consistent flavor delivery, ease of manufacturing, and suitability for automated assembly.

At present, ceramic vaporizing cores available on the market include tripod-like structures, annular column structures, and other structural types. Among them, the ceramic vaporizing cores suitable for MESH are primarily of annular configuration influenced by the design of a heating mesh structure. However, a heating surface of the annular structure can only be limited to an air channel on an inner surface, resulting in relatively low vapor output and poor reproduction of the sweetness and aroma of the e-liquid, making it difficult to achieve the flavor performance of cotton vaporizing cores, and delivering a negative impact on user experience.

### SUMMARY OF THE INVENTION

In view of the foregoing defects, the present disclosure provides a vaporizing core, an injection mold for a vaporizing core, an injection molding method therefor and an electronic cigarette. By means of a reasonable internal structural design of a vaporizing core, an internal surface area of the heating mesh is increased, thereby addressing the technical problems that the heating surface of the annular structure is only limited to an air passage on an inner surface, resulting in relatively low vapor output and poor reproduction of the sweetness and aroma of the e-liquid, making it difficult to achieve the flavor performance of cotton vaporizing cores, and delivering a negative impact on user experience.

Therefore, in a first aspect, the prevent disclosure provides a heating mesh, including:
a heating mesh body, where the heating mesh body is a mesh structure; and
the heating mesh body is formed into a non-enclosed structure by bending.

The heating mesh adopts a mesh structure design, where the heating mesh body is formed into a non-enclosed structure by bending; and during injection molding with the ceramic core, the non-enclosed heating mesh body can closely adhere to the inner wall of the ceramic core, thereby preventing embedding or detachment, and improving vaporization performance. In addition, this design solves the problem of complex bending process of the enclosed MESH-type heating mesh.

In one possible implementation mode, the heating mesh further includes:
an outer frame and a connecting portion, where the outer frame is connected to the heating mesh body via the connecting portion.

In one possible implementation mode, a breaking point is formed at a connection position between the connecting portion and the heating mesh body.

In one possible implementation mode, the breaking point is an etched breaking point.

In one possible implementation mode, a bent part of the heating mesh body is rectangular or arc-shaped.

In one possible implementation mode, the bending is implemented by a bending jig, where the bending jig includes an upper mold, a lower mold, and a bending assembly;
the upper mold is positioned in alignment with the lower mold, the upper mold and the lower mold are capable of performing relative movement in a vertical direction, and a processing space is formed between the upper mold and the lower mold for accommodating the heating mesh body to be bent; and
the bending assembly is mounted on the upper mold and the lower mold, and is configured to bend the heating mesh body to be bent into a heating mesh of a preset shape.

The bending jig is provided with an upper mold and a lower mold, and a processing space is formed between the upper mold and the lower mold to accommodate the heating mesh body to be bent. The upper model and the lower mold move relative to each other in a vertical direction, and the bending assembly bends the heating mesh body into a finished product of a preset shape, such that the heating mesh is fabricated, and the manufacturing process of the bending jig is simple, low-cost, and easy to operate.

In one possible implementation mode, the upper mold includes a top cover and an upper pressing mold body, the top cover is disposed above the upper pressing mold body, and the top cover is connected to the upper pressing mold body by fixing bolts.

In one possible implementation mode, the lower mold includes a base and a lower pressing mold body, the base is disposed below the lower pressing mold body, the base is connected to the lower pressing mold body by fixing bolts, and a receiving groove is formed on an upper surface of the lower pressing mold body.

In one possible implementation mode, the bending jig further includes a fixing assembly, where the fixing assembly is mounted on an upper surface of the lower mold and is configured to fix the heating mesh body to be bent in place.

In one possible implementation mode, the fixing assembly is a positioning pin.

In one possible implementation mode, the bending assembly includes a fixed upper pressing blade, a fixed lower pressing blade, and a spring;
a spring cavity is formed on the upper mold in an axis direction, and the spring is disposed in the spring cavity;
the fixed upper pressing blade is disposed in the spring cavity and extends into the processing space in a length direction of the spring cavity, one end of the fixed upper pressing blade is connected to the spring, a blade groove having a preset shape is formed on a free end of the fixed upper pressing blade, and the fixed upper pressing blade is capable of performing relative movement in the length direction of the spring cavity; and
the fixed lower pressing blade is mounted in the receiving groove, and a free end of the fixed lower pressing blade corresponds to a position of the blade groove of the fixed upper pressing blade and is configured to be structurally matched to the blade groove.

In one possible implementation mode, the bending assembly further includes two bending blades, where the two bending blades are respectively mounted on opposite sides of the fixed upper pressing blade and extend into the processing space, and positions of the bending blades correspond to a position of the receiving groove.

In one possible implementation mode, the bending jig further includes a guiding assembly. The guiding assembly is mounted on the upper mold and the lower mold, and is configured to constrain relative movement of the upper mold and the lower mold in the vertical direction.

In one possible implementation mode, the guiding assembly includes a guiding post and a guiding groove adapted to a structure of the guiding post, the guiding post is disposed on a lower surface of the upper mold, and the guiding groove is formed on the upper surface of the lower mold and corresponds to a position of the guiding post.

In a second aspect, the present disclosure further provides a vaporizing core, including a porous body and the heating mesh as described in the first aspect; and
the porous body is provided with a vaporizing chamber having a square chamber structure, the heating mesh is embedded in an inner wall of the vaporizing chamber, and an end of the porous body near a vapor outlet is provided with a ring-shaped vapor duct structure.

For the vaporizing core provided in the present disclosure, the porous body is provided with a vaporizing chamber having a square chamber structure, and the heating mesh is embedded in an inner wall of the vaporizing chamber. Compared with the traditional ring-shaped ceramic vaporizing core, an area of the internal heating mesh area is enlarged, and a vapor output is increased. In addition, a ring-shaped vapor duct structure is disposed at a top of the porous body, which restores the smoking sensation similar to that of a cigarette, and enhances the aroma and sweetness of the vapor, fully restores the original flavor of the e-liquid in combination with the vaporizing chamber structure, making the taste reach the effect of a cotton core and improving user experience.

In one possible implementation mode, the porous body is of a porous structure.

In one possible implementation mode, an external structure of the porous body is cylindrical.

In one possible implementation mode, the vaporizing chamber is connected to and integrally formed with the ring-shaped vapor duct structure.

In one possible implementation mode, a surface of the ring-shaped vapor duct structure connected to the vaporizing chamber is a concave-convex surface.

In one possible implementation mode, a diameter of the ring-shaped vapor duct structure is smaller than a cross-sectional width of the vaporizing chamber.

In one possible implementation mode, at least three surfaces of the inner wall of the vaporizing chamber are provided with the heating meshes.

In a third aspect, the present disclosure further provides an injection mold for a vaporizing core, including an injection molding module and a molding module, where the injection molding module is disposed above the molding module;
the injection molding module includes an injection gate and an injection runner;
the injection gate is arranged above the injection runner, and the injection gate is in fluid communication with an inlet end of the injection runner;
the molding module includes a molding shell and a limiting post; and
a molding cavity is formed inside the molding shell, the molding cavity is in fluid communication with an outlet end of the injection runner, the limiting post is horizontally arranged inside the molding cavity, and each outer wall of the limiting post is provided with an injection molding fitting surface on which the heating mesh is adhered, such that the heating mesh is injection molded together with injection molding slurry to form the vaporizing core as described in the second aspect.

The injection mold for a vaporizing core places the heating mesh on the injection molding fitting surface of the limiting post, the injection molding slurry is injected from the injection gate and flows through the injection runner into the molding cavity. Since the limiting post is horizontally disposed inside the molding cavity, the heating mesh is pressed more tightly against the limiting post under pressure, such that the semi-enclosed heating mesh can be hot-pressed and injection-molded using a mold, solving the problems that the heating mesh cannot properly adhere to the ceramic surface and tends to embed into the ceramic due to the flow of ceramic slurry, slurry pressure, and poor mold fixation.

In one possible implementation mode, the injection molding module further includes a cover plate, the injection gate is provided on an upper surface of the cover plate, and the injection runner is formed inside the cover plate.

In one possible implementation mode, a limiting groove in fluid communication with the molding cavity is formed inside the molding shell, and the limiting post is disposed inside the limiting groove and extends into the molding cavity.

In one possible implementation mode, a receiving gap is formed between the limiting post and an inner wall of the limiting groove, and the receiving gap is configured to fix a pin portion of the heating mesh.

In one possible implementation mode, the heating mesh is fitted onto the injection molding fitting surface, and an opening of the heating mesh is formed downward.

In one possible implementation mode, the injection mold for a vaporizing core further includes a demolding module, where the demolding module is disposed below the molding module, and the demolding module is connected to the molding module by fixing bolts.

In one possible implementation mode, the injection mold for a vaporizing core further includes an injection base disposed below the demolding module, and the injection base is connected to the demolding module by fixing bolts.

In a fourth aspect, the present disclosure further provides an injection molding method for a vaporizing core, and the method adopts the injection mold for a vaporizing core as described in the third aspect, including:
adhering the heating mesh to the injection molding fitting surface of the limiting post; and
injecting injection molding slurry from the injection gate, allowing the injection molding slurry to flow through the injection runner into the molding cavity, causing the heating mesh to be subjected to pressure from the injection molding slurry, and molding into the vaporizing core as described in the second aspect.

Based on the same inventive concept of the injection mold for a vaporizing core as described in the third aspect, the injection molding method for a vaporizing core is obtained. The injection mold for a vaporizing core places the heating mesh on the injection molding fitting surface of the limiting post, the injection molding slurry is injected from the injection gate and flows through the injection runner into the molding cavity. Since the limiting post is horizontally disposed inside the molding cavity, the heating mesh is pressed more tightly against the limiting post under pressure, such that the semi-enclosed heating mesh can be hot-pressed and injection-molded using a mold, solving the problems that the heating mesh cannot properly adhere to the ceramic surface and tends to embed into the ceramic due to the flow of ceramic slurry, slurry pressure, and poor mold fixation.

In a fifth aspect, the present disclosure further provides a vaporizer, including the vaporizing core as described in the second aspect.

In a sixth aspect, the present disclosure further provides an electronic vaporizing device, including the vaporizer as described in the fifth aspect and a power supply, and the power supply is electrically connected to the vaporizer to supply power to the vaporizer.

In a seventh aspect, the present disclosure further provides an electronic cigarette, where the electronic cigarette includes the electronic vaporizing device as described in the sixth aspect.

Since the vaporizer, the electronic vaporizing device and the electronic cigarette all incorporate the vaporizing core as described in the second aspect. Therefore, the technical effects that can be achieved by the vaporizer, the electronic vaporizing device and the electronic cigarette of the present disclosure may be referred to the technical effects achieved by the vaporizing core as described in the second aspect, and will not be repeated here.

### DESCRIPTION OF THE DRAWINGS

In order to more clearly illustrate technical solutions in the embodiments of the present disclosure or in the prior art, a brief introduction to the accompanying drawings required for the description of the embodiments or the prior art will be provided below. Obviously, the accompanying drawings in the following description are only some of the embodiments of the present disclosure, and those ordinary skilled in the art would also be able to derive other drawings from these drawings without making creative efforts.

FIG. 1 is a schematic structural diagram of a heating mesh before bending according to a first embodiment of the present disclosure.

FIG. 2 is a schematic structural diagram of a heating mesh after bending according to a first embodiment of the present disclosure.

FIG. 3 is a schematic diagram of one C-shaped non-enclosed structure.

FIG. 4 is a schematic diagram of another C-shaped non-enclosed structure.

FIG. 5 is a schematic structural diagram of a heating mesh body having a mesh structure.

FIG. 6 is a schematic structural diagram of a heating mesh before bending corresponding to a heating mesh body having an arc shape at a bent part.

FIG. 7 is a schematic structural diagram of a heating mesh after bending corresponding to a heating mesh body having an arc shape at a bent part.

FIG. 8 is a schematic diagram of a front view structure of a bending jig.

FIG. 9 is a schematic diagram of a front sectional view structure of a bending jig.

FIG. 10 is a partial schematic structural diagram of a bending assembly.

FIG. 11 is a schematic diagram of a three-dimensional structure of a vaporizing core according to a second embodiment of the present disclosure.

FIG. 12 is a schematic diagram of a sectional structure of a vaporizing core according to a second embodiment of the present disclosure.

FIG. 13 is a schematic diagram of a top view structure of a vaporizing core according to a second embodiment of the present disclosure.

FIG. 14 is a schematic diagram of a bottom view structure of a vaporizing core according to a second embodiment of the present disclosure.

FIG. 15 is a schematic diagram of a three-dimensional structure of an injection mold for a vaporizing core according to a third embodiment of the present disclosure.

FIG. 16 is a schematic diagram of a front sectional view structure of an injection mold for a vaporizing core according to a third embodiment of the present disclosure.

FIG. 17 is a schematic diagram of a molding shell of an injection mold for a vaporizing core according to a third embodiment of the present disclosure.

FIG. 18 is a schematic structural diagram of a limiting groove.

FIG. 19 is a schematic structural diagram of a traditional injection mold.

FIG. 20 is a flowchart of an injection molding method for a vaporizing core according to a fourth embodiment of the present disclosure

FIG. 21 is a schematic structural diagram of a vaporizer according to a fifth embodiment of the present disclosure.

FIG. 22 is a schematic structural diagram of an electronic vaporizing device according to a sixth embodiment of the present disclosure.

FIG. 23 is a schematic structural diagram of an electronic cigarette according to a seventh embodiment of the present disclosure.

### DETAILED DESCRIPTION OF THE EMBODIMENTS

In order to enable those skilled in the art to better understand the technical solutions of the present disclosure, the technical solutions of embodiments of the present disclosure will be described below clearly and comprehensively in conjunction with accompanying drawings of the embodiments of the present disclosure. Apparently, the embodiments described are merely some embodiments rather than all embodiments of the present disclosure. Based on the embodiments of the present disclosure, all the other embodiments obtained by those of ordinary skill in the art without making creative efforts shall fall within the scope of protection of the present disclosure.

At present, ceramic heating meshes used in electronic cigarettes mainly have two structures: a nautilus-shaped enclosed heating mesh and a complete ceramic core that is directly prepared using a thick-film printing method. Specifically, the MESH-type heating sheet has rapidly replaced the nautilus-shaped heating mesh and thick-film printed heating mesh due to its excellent vaporization performance and longer service life.

The MESH heating mesh have two main structures on the market, that is, a ring-shaped closed structure and a sheet-shaped structure. Both of the two structures are mesh sheet structure fabricated by mechanical stamping or etching. For the ring-shaped closed structure, the mesh is bent into a circular shape using a mechanical mold to form a complete heating mesh. For the sheet-shaped structure, after being welded with a lead wire, the mesh is directly placed into an injection mold for molding.

For the ring-shaped closed structure, the heating mesh is pre-formed before injection molding, the heating mesh after the injection molding thus adheres closely to an inner wall of the ceramic core, such that a vaporizing core with good performance is fabricated. However, this method involves complex processing technology, high fabrication difficulty, and expensive production equipment.

For the sheet-shaped structure, after being placed in a bending mold, the mesh tends to spring back due to a stress of the metal, which may cause the heating mesh to be embedded in the ceramic core, thereby easily resulting in lower vapor output, and carbon deposition, and deteriorating the overall vaporization performance.

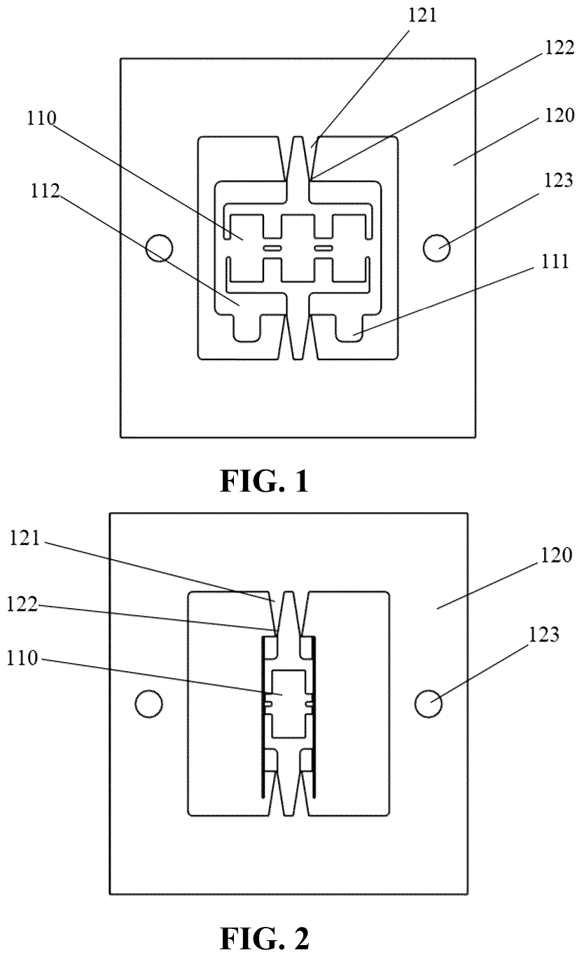

Therefore, in a first embodiment of the present disclosure, a heating mesh is provided to address the above-mentioned problems. As shown in FIGS. 1 and 2, FIG. 1 illustrates a structure of a heating mesh before being bent according to the first embodiment of the present disclosure, and FIG. 2 illustrates a structure of the heating mesh after being bent according to the first embodiment of the present disclosure.

The heating mesh provided in the first embodiment of the present disclosure includes:
a heating mesh body 110, where the heating mesh body 110 is a mesh structure; and
the heating mesh body 110 is formed into a non-enclosed structure by bending.

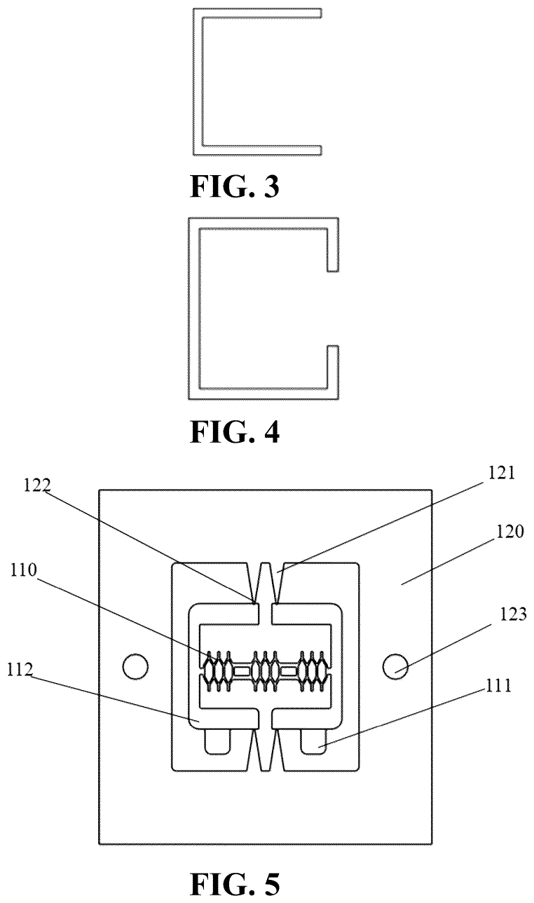

Specifically, the non-enclosed structure may be a C-shaped non-enclosed structure, where the C-shaped non-enclosed structure refers to a semi-enclosed structure. For the structure, an overall shape of the heating mesh body 110 is not enclosed. According to a semi-enclosed degree of the heating mesh body 110, the non-enclosed structure can be further classified into two types: one is the C-shaped structure shown in FIG. 3, and the other is the C-shaped structure shown in FIG. 4.

In one possible implementation mode, as shown in FIG. 1, the heating mesh body 110 is a sheet-shaped structure with a specific shape. In another example, as shown in FIG. 5, FIG. 5 illustrates a heating mesh body having a mesh structure, and the heating mesh body 110 is a sheet-shaped structure having a mesh structure.

A bent part of the heating mesh body 110 is rectangular, and the heating mesh body 110 is further provided with a lead welding portion 111 configured to secure electrical leads.

The heating mesh body 110 having a rectangular bent part is further provided with an outer support frame 112 for supporting an overall structure inside the heating mesh body 110.

In some embodiments, the heating mesh body 110 further includes an outer frame 120 and a connecting portion 121, and the outer frame 120 is connected to the heating mesh body 110 via the connecting portion 121.

Specifically, the connecting portion 121 is connected to a middle position along an outer edge of the heating mesh body 110 and is configured to provide support when the heating mesh body 110 is bent. In addition, fixing holes 123, generally two or more than two holes, are formed on the outer frame 120, which is not limited herein.

The fixing holes 123 are configured to fix during bending and ceramic forming processes.

A breaking point 122 is formed at a connection position between the connecting portion 121 and the heating mesh body 110.

The breaking point 122 is configured to facilitate the breaking of the heating mesh body 110, the breaking point 122 may be implemented as etched breaking point, and more than two etched breaking points are generally provided to facilitate breaking and separation of the heating mesh body 110 from the outer frame 120.

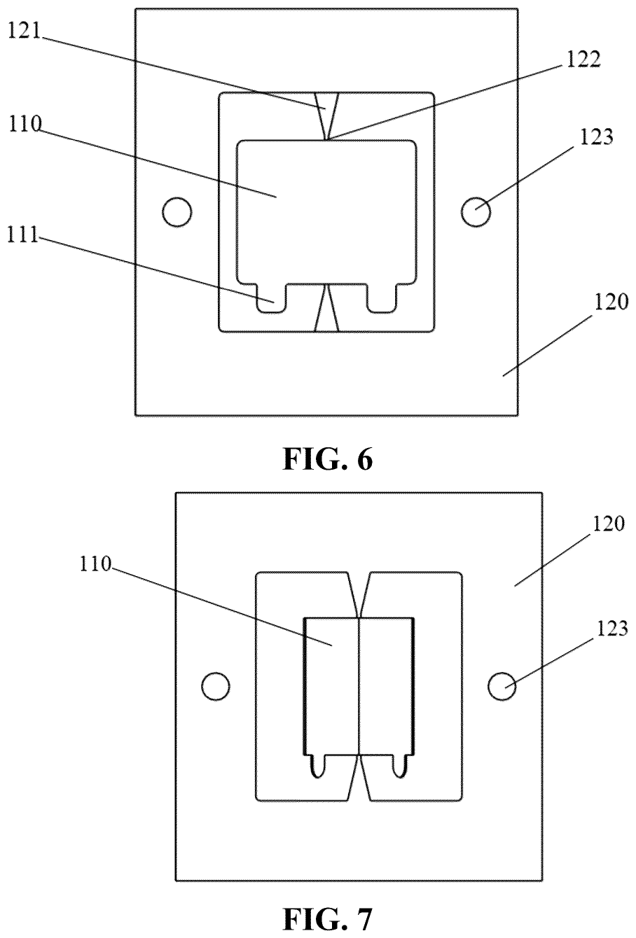

The bent part of the heating mesh body 110 may also have an arc shape. A structure of the heating mesh body 110 having an arc-shaped bent part before bending is shown in FIG. 6, and structure of the heating mesh body 110 having an arc-shaped bent part after bending is shown in FIG. 7.

It should be noted that the heating mesh provided in the first embodiment of the present disclosure has a mesh structure, and the heating mesh body thereof is formed into a non-enclosed structure by bending. During injection molding with the ceramic core, the non-enclosed heating mesh body can closely adhere to the inner wall of the ceramic core, thereby preventing embedding or detachment, and improving vaporization performance. In addition, the structure solves the problem of complex bending process of the enclosed MESH-type heating mesh.

A manufacturing process of the heating mesh provided in an embodiment of the present disclosure includes the following steps:

First, a structure shown in FIG. 1 is obtained by removing mesh surface and unwanted metal portions using etching or stamping according to the design requirements of the drawing, and the structure is further bent with a bending jig to obtain a structure shown in FIG. 2.

After being formed, the heating mesh is embedded on a ceramic surface via hot die casting or injection molding, and then vaporized after being heated by power supply. Specifically, the heating mesh is placed into an injection mold, and a ceramic slurry is then injected to form a ceramic body to obtain a sample structure of the heating mesh after injection molding; and after sintering, the outer frame 120 of the heating mesh is removed to obtain a sample structure of the heating mesh after sintering, such as the vaporizing core.

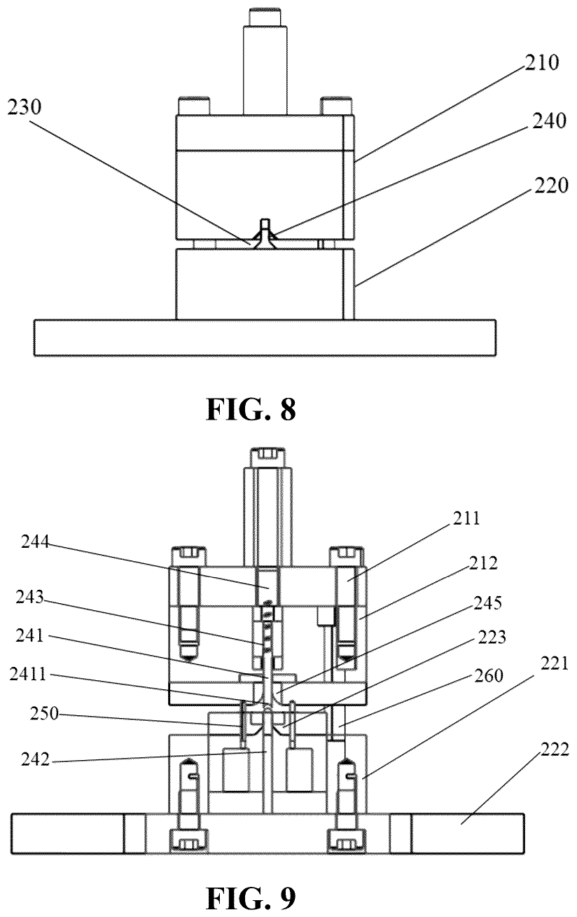

It should be noted that when the heating mesh is pre-formed into a ring-shaped or enclosed structure, the heating mesh does not need to be fixed by external force from the ceramic slurry. Although the method provides a good fit between the ceramic core and the heating mesh, it requires higher manufacturing equipment for the heating mesh and involves more complex processing steps. Therefore, in an embodiment of the present disclosure, the bending jig is used to bend the heating mesh body to bend the heating mesh body, thereby solving the technical problems of higher manufacturing equipment and involves more complex processing step in the production of the heating mesh. As shown in FIGS. 8-9, a bending jig provided in an embodiment of the present disclosure includes: an upper mold 210, a lower mold 220, and a bending assembly 240;
the upper mold 210 is positioned in alignment with the lower mold 220, the upper mold 210 and the lower mold 220 are capable of performing relative movement in a vertical direction, and a processing space 230 is formed between the upper mold 210 and the lower mold 220 for accommodating the heating mesh body to be bent; and
the bending assembly 240 is mounted on the upper mold 210 and the lower mold 220, and is configured to bend the heating mesh body to be bent into a heating mesh of a preset shape.

It should be noted that a working process of the bending jig in this embodiment is as follows:

The heating mesh body to be bent is placed in the processing space 230. In a general example, the heating mesh body to be bent is positioned on the lower mold 220, as the upper mold 210 moves up and down relative to the lower mold 220, the bending assembly 240 performs bending operations on the heating mesh body, such that the heating mesh body forms a heating mesh of the preset shape.

Specifically, the preset shape is defined based on the shape of the bent part of the heating mesh body and may include rectangular, arc-shaped, or square, etc., which is not limited herein.

In one possible implementation mode, the upper mold 210 includes a top cover 211 and an upper pressing mold body 212, the top cover 211 is disposed above the upper pressing mold body 212, and the top cover 211 is connected to the upper pressing mold body 212 by fixing bolts.

The lower mold 220 includes a base 222 and a lower pressing mold body 221, the base 222 is disposed below the lower pressing mold body 221, the base 222 is connected to the lower pressing mold body 221 by fixing bolts, and a receiving groove 223 is formed on an upper surface of the lower pressing mold body 221.

In addition, the bending jig further includes a fixing assembly, where the fixing assembly is mounted on an upper surface of the lower mold 220 and is configured to fix the heating mesh body to be bent in place.

In a preferred embodiment, the fixing assembly is a positioning pin 250, and two positioning pin may be provided.

In practical application, the two positioning pins are mounted on the upper surface of the lower mold 220, and the heating mesh body to be bent is fixed by the positioning pins 250.

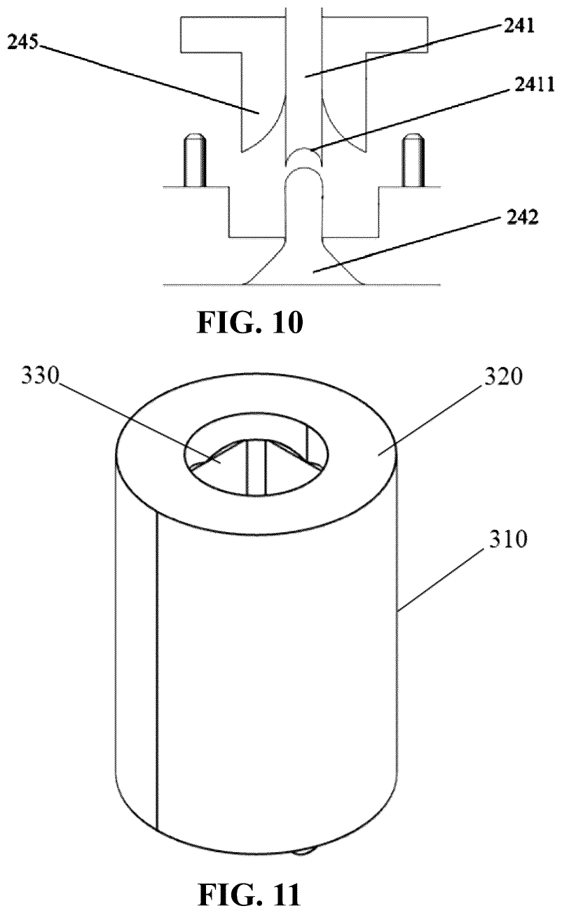

In one possible implementation mode, as shown in FIG. 10, FIG. 10 illustrates a partial structure of the bending assembly 240, where the bending assembly 240 includes a fixed upper pressing blade 241, a fixed lower pressing blade 242, and a spring 243;
a spring cavity 244 is formed on the upper mold 210 in an axis direction, and a spring 243 is disposed in the spring cavity 244;
the fixed upper pressing blade 241 is disposed in the spring cavity 244 and extends into the processing space 230 in a length direction of the spring cavity 244, one end of the fixed upper pressing blade 241 is connected to the spring 243, a blade groove 2411 having a preset shape is formed on a free end of the fixed upper pressing blade 241, and the fixed upper pressing blade 241 is capable of performing relative movement in the length direction of the spring cavity 244; and
the fixed lower pressing blade 242 is mounted in the receiving groove 223, and a free end of the fixed lower pressing blade 242 corresponds to a position of the blade groove 2411 of the fixed upper pressing blade 241 and is configured to be structurally matched to the blade groove.

Specifically, the receiving groove 223 is configured to receive the bent part of the heating mesh body, and a groove surface structure of the blade groove 2411 defines the shape of the heating mesh body to be bent after being bent.

In one possible implementation mode, the bending assembly 240 further includes two bending blades 245, where the two bending blades 245 are respectively mounted on opposite sides of the fixed upper pressing blade 241 and extend into the processing space 230, and positions of the bending blades 245 correspond to a position of the receiving groove 223.

A maximum width between the two bending blades 245 is not greater than a width of the receiving groove 223, the bending blades 245 are disposed vertically relative to the heating mesh body to be bent, and the bending blades 245 are configured to bend the heating mesh body to be bent and form a right angle at a bending point.

In another possible implementation mode, the bending jig further includes a guiding assembly, the guiding assembly is mounted on the upper mold 210 and the lower mold 220, and is configured to constrain relative movement of the upper mold 210 and the lower mold 220 in the vertical direction.

In a specific embodiment, the guiding assembly includes a guiding post 260 and a guiding groove adapted to a structure of the guiding post 260, the guiding post 260 is disposed on a lower surface of the upper mold 210, and the guiding groove is formed on the upper surface of the lower mold 220 and corresponds to a position of the guiding post 260.

In practical applications, in order to ensure more stable movement, the guiding post 260 and the guiding groove are each provided in pairs and arranged on either sides of the bending assembly 240, respectively; and in addition, a depth of the guiding groove is greater than a length by which the guiding post 260 extends.

Taking a bending jig for manufacturing a C-shaped heating mesh as an example, a bending process is as follows: the fixing hole 123 on the outer frame of the heating mesh shown in FIG. 1 is inserted into the positioning pin 250 to fix the heating mesh. A middle portion of the heating mesh is attached to the fixed lower pressing blade 242, pressure is applied downward to the upper mold 210 by a hand press machine, and the upper mold 210 moves downward in a vertical direction under the restriction of the guiding post 260.

The fixed upper pressing blade 241 first contacts a mesh surface of the heating mesh, and clamps the heating mesh together with the fixed lower pressing blade 242, after then, the fixed upper pressing blade 241 ceases to move downward, and when it continues to move downward, the heating mesh is compressed more tightly by the spring 243. Afterward, the upper mold 210 continues to move downward, the bending blades 245 then contact the heating mesh, and when it continues to move downward, the bending blades 245 exert downward force onto the heating mesh. When a lower limit position of the bending jig is reached, the heating mesh is bent by the bending blades 245 to a final vertical position, in which case, the heating mesh is bent to a desired position, and then restores to an upper limit position of the bending jig, and the entire bending operation is completed, forming the C-shaped heating mesh structure as shown in FIG. 2.

It should be noted that the bending jig in an embodiment of the present disclosure is provided with an upper mold and a lower mold, and a processing space is formed between the upper mold and the lower mold to accommodate the heating mesh body to be bent. The upper model and the lower mold move relative to each other in a vertical direction, and the bending assembly bends the heating mesh body into a finished product of a preset shape, such that the heating mesh is fabricated, and the manufacturing process of the bending jig is simple, low-cost, and easy to operate.

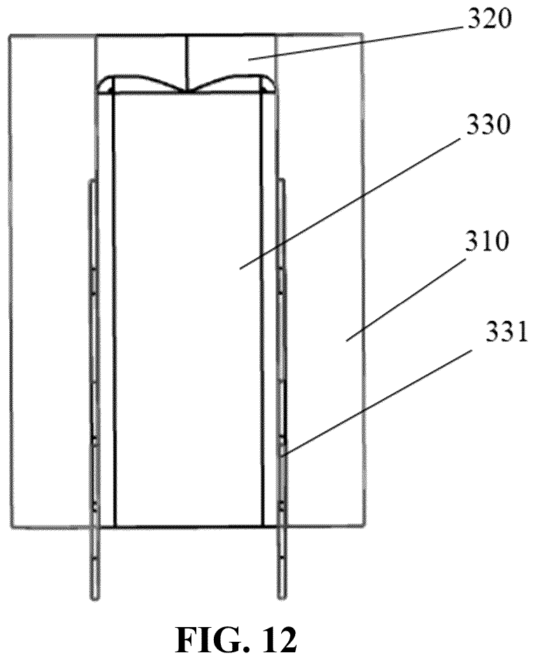

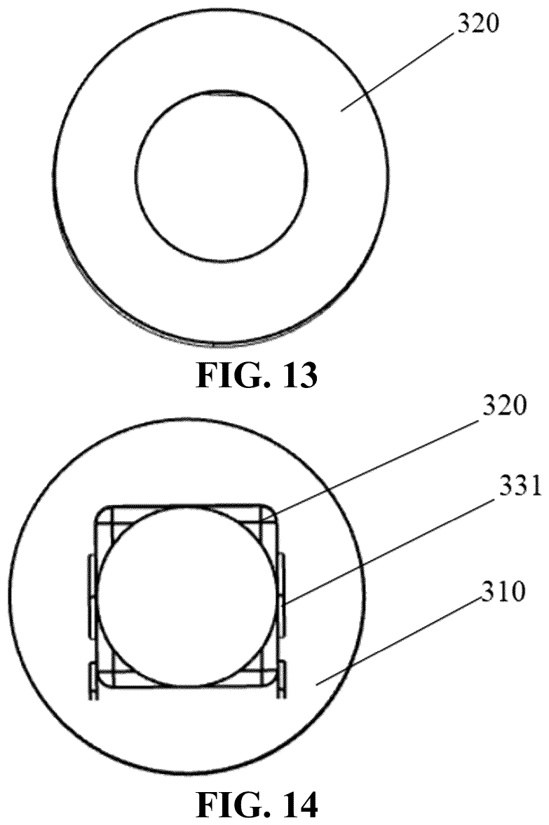

As shown in FIGS. 11-14, a second embodiment of the present disclosure provides a vaporizing core. FIG. 11 illustrates a perspective structure of the vaporizing core provided in the second embodiment of the present disclosure, FIG. 12 illustrates a cross-sectional structure of the vaporizing core provided in the second embodiment of the present disclosure, FIG. 13 illustrates a top view structure of the vaporizing core provided in the second embodiment of the present disclosure, and FIG. 14 illustrates a bottom view structure of the vaporizing core provided in the second embodiment of the present disclosure.

The vaporizing core provided in the second embodiment includes a porous body 310 and the heating mesh 331 as described in the first embodiment; and
the porous body 310 is provided with a vaporizing chamber 330 having a square chamber structure, the heating mesh 331 is embedded in an inner wall of the vaporizing chamber 330, and an end of the porous body 310 near a vapor outlet is provided with a ring-shaped vapor duct structure 320.

It should be noted that the porous body 310 is of a porous structure, the porous body 310 may be a hollow tubular structure with two ports, and either of the ports may serve as the vapor outlet, which is not limited herein. Further, as a preferred example, the ring-shaped vapor duct structure 320 is disposed at the end of the vapor outlet of the porous body 310.

In one possible implementation mode, the porous body 310 is made of ceramic material. In addition, an external structure of the porous body 310 is cylindrical, and an outer surface of the porous body 310 is in contact with an oil chamber of the vaporizing device. The porous body 310 is of a hollow structure, the e-liquid is conducted to an inner surface of the vaporizing chamber 330 through the ceramic porous body 310, and activated by the heating mesh 331 on the inner wall of the vaporizing chamber 330 to achieve the vaporization effect.

Specifically, the vaporizing chamber 330 may be a square-shaped cavity structure, at least three surfaces of the inner wall of the vaporizing chamber are provided with the heating meshes. As a preferred example, the heating mesh 331 is arranged on each inner wall of the vaporizing chamber 330. Therefore, each inner wall of the vaporizing chamber 330 participates in vaporization. Compared with the traditional ring-shaped ceramic vaporizing core structure, this design increases a heating area while ensuring a structural strength of the ceramic structure, resulting in better vaporization performance. In addition, a thicker wall region of the cavity can store more e-liquid, preventing carbon deposition caused by dry burning, thereby prolonging a service life of the vaporizing core.

Furthermore, the square-shaped cavity structure of the vaporizing chamber 330 can improve an oil conduction rate of the ceramic. On one hand, the e-liquid can be introduced from the thicker wall region of the cavity; on the other hand, a thinner wall region of the vaporizing chamber 330 has a higher oil conduction rate. When entering the thinner wall region of the vaporizing chamber, the e-liquid diffuses outward in four directions due to capillary phenomenon, increasing the oil conduction rate of the thicker wall region and ensuring the consistency of taste.

In practical application, a small amount of vaporized e-liquid remains in the square-shaped chamber of the vaporizing chamber 330 during an interval between puffs, ensuring that the temperature will not drop to a condensation point of the e-liquid, reducing the condensation of e-liquid on the heating mesh 331, and causing carbon deposition during second vaporization, which can better improve the service life and taste consistency of the ceramic vaporizing core.

In one possible implementation mode, as shown in FIGS. 11-12, the vaporizing chamber 330 is connected to and integrally formed with the ring-shaped vapor duct structure 320, where the vaporizing chamber 330 is communicated with the ring-shaped vapor duct structure 320.

In order to increase the suction resistance, a surface connecting the ring-shaped vapor duct structure 320 connected to the vaporizing chamber 330 is a concave-convex surface, and a diameter of the ring-shaped vapor duct structure 320 is smaller than a cross-sectional width of the vaporizing chamber 330.

In practical application, on the one hand, the ring-shaped vapor duct structure 320 restores the smoking sensation similar to that of a cigarette. On the other hand, the ring-shaped vapor duct structure 320 gathers and draws out a large amount of vapor particles (aerosol particles) in the vaporizing chamber 330 below the ring-shaped vapor duct structure, which enhances the aroma and sweetness of the vapor, fully restores the original flavor of the e-liquid, and making the taste reach the effect of a cotton core.

It should be noted that the second embodiment of the present disclosure provides a vaporizing core, the porous body is provided with a vaporizing chamber having a square chamber structure, and the heating mesh is embedded in an inner wall of the vaporizing chamber. Compared with the traditional ring-shaped ceramic vaporizing core, an area of the internal heating mesh area is enlarged, and a vapor output is increased. In addition, a ring-shaped vapor duct structure is disposed at a top of the porous body, which restores the smoking sensation similar to that of a cigarette, and enhances the aroma and sweetness of the vapor, fully restores the original flavor of the e-liquid in combination with the vaporizing chamber structure, making the taste reach the effect of a cotton core and improving user experience.

For the traditional vertical heating mesh injection molds, the heating mesh is fixed on the limiting posts in the cavity, ceramic slurry is injected into a molding cavity from a top, the heating mesh combines with the ceramic slurry in the molding cavity, the heating mesh adheres to an inner surface of the ceramic cavity, and the ceramic heating core is then prepared.

However, the C-shaped or other semi-enclosed heating meshes cannot properly adhere to the ceramic surface and tends to embed into the ceramic due to the flow of ceramic slurry, slurry pressure, and poor mold fixation. In addition, when the heating mesh is embedded into the ceramic, the heating performance of the ceramic heating core will be affected, leading to rapid carbon deposition and a burnt smell during vaporization, reduced vapor output, and poor vaporization effects.

Therefore, a third embodiment of the present disclosure provides an injection mold for the vaporizing core. Specifically, a device for hot pressing and injection molding a semi-enclosed heating mesh is provided, which solves the technical problems that the heating mesh cannot properly adhere to the ceramic surface and tends to embed into the ceramic due to the flow of ceramic slurry, slurry pressure, and poor mold fixation.

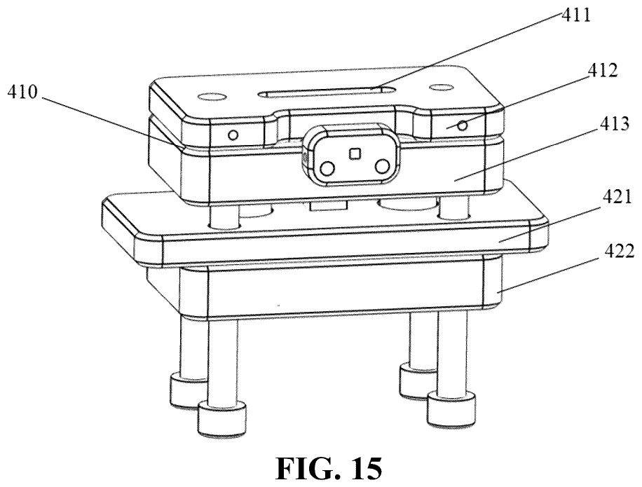

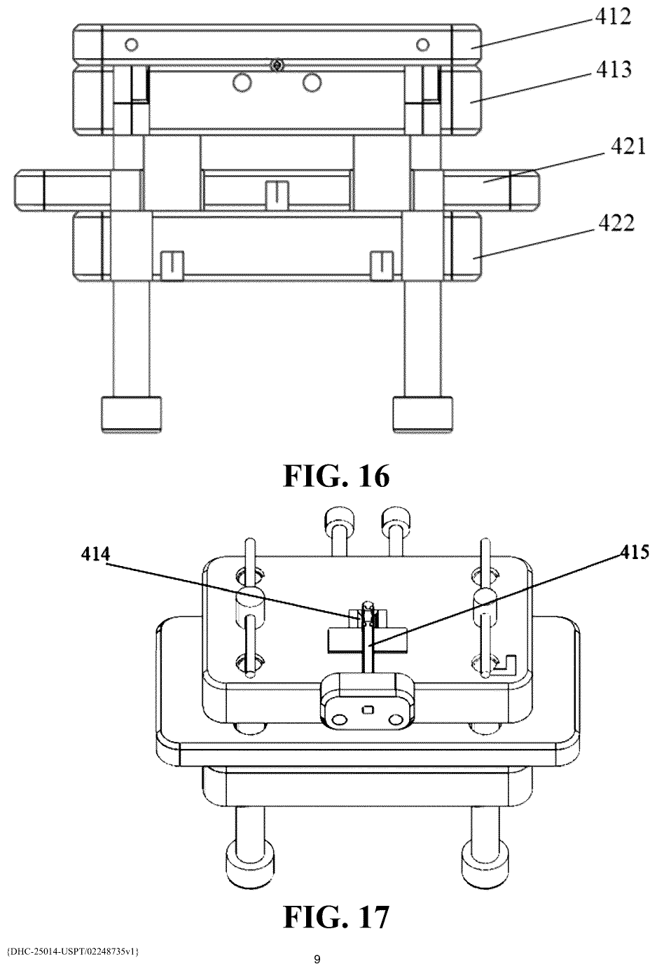

As shown in FIGS. 15-16, FIG. 15 illustrates a perspective view of a structure of an injection mold for a vaporizing core provided in the third embodiment of the present disclosure, and FIG. 16 illustrates a front sectional view of a structure of an injection mold for a vaporizing core provided in the third embodiment of the present disclosure.

The injection mold for a vaporizing core provided in the third embodiment of the present disclosure includes an injection molding module 410 and a molding module 420, where the injection molding module 410 is disposed above the molding module 420.

The injection molding module 410 includes an injection gate 411 and an injection runner, where the injection gate 411 is arranged above the injection runner, and the injection gate 411 is in fluid communication with an inlet end of the injection runner.

FIG. 17 illustrates a structure of a molding shell of the injection mold for a vaporizing core provided in the third embodiment of the present disclosure. The molding module 420 includes a molding shell 413 and a limiting post 415, a molding cavity 414 is formed inside the molding shell 413, the molding cavity 414 is in fluid communication with an outlet end of the injection runner, the limiting post 415 is horizontally arranged inside the molding cavity 414, and each outer wall of the limiting post 415 is provided with an injection molding fitting surface on which the heating mesh is adhered, such that the heating mesh is injection molded together with injection molding slurry to form the vaporizing core as described in the second embodiment.

The limiting post 415 is a solid post, a cross-sectional structure of the limiting post 415 is defined based on a shape of the heating mesh, which may be circular, square, or rectangular, and is not limited herein.

In one possible implementation mode, the injection molding module 410 further includes a cover plate 412, the injection gate 411 is provided on an upper surface of the cover plate 412, and the injection runner is formed inside the cover plate 412.

Specifically, the molding shell 413 and the cover plate 412 are connected by fixing bolts, a limiting groove in fluid communication with the molding cavity 414 is formed inside the molding shell 413, and the limiting post 415 is disposed inside the limiting groove and extends into the molding cavity 414.

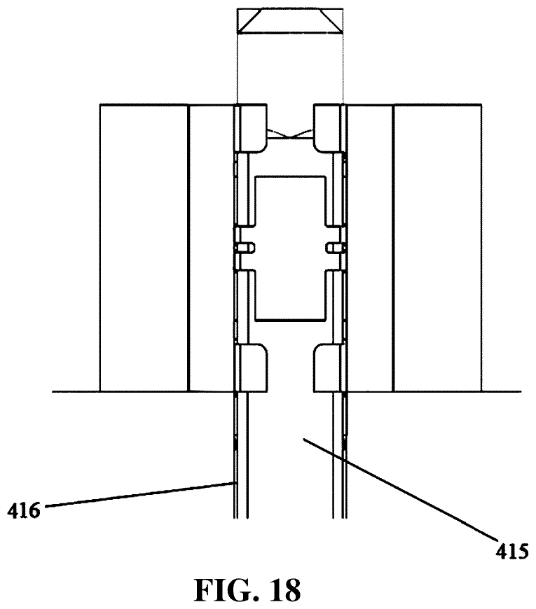

As shown in FIG. 18, FIG. 18 illustrates a structure of the limiting groove, the limiting post 415 is disposed in a length direction of the limiting groove, a receiving gap 416 is formed between the limiting post 415 and an inner wall of the limiting groove, and the receiving gap is configured to fix a pin portion of the heating mesh.

It can be understood that the heating mesh is provided with pins that need to be exposed, therefore, the injection molding is not required, positions of the pins can be fixed by the receiving gap, and the receiving gap 416 is defined based on a thickness of the pin, which is not limited herein.

In order to ensure that the heating mesh fits more closely to the limiting post 415 during the injection molding process, the C-shaped semi-enclosed heating mesh is fitted onto the injection molding fitting surface, a C-shaped opening of the heating mesh of the C-shaped semi-enclosed structure is formed downward, such that most of the surface of the heating mesh is subjected to a pressure of the slurry, mesh sheets of the heating mesh fit tightly against an outer surface of the limiting post 415 without embedding into the slurry. A mesh sheet on either side of the heating mesh has a smaller area, and is almost not subjected to the pressure from the slurry, but is tightly pressed against the limiting post 415 by the pins.

In some embodiments, the injection mold further includes a demolding module 421, where the demolding module 421 is disposed below the molding module 420, and the demolding module 421 is connected to the molding module 420 by fixing bolts.

It can be understood that the demolding module 421 may be used to demold the finished product after the injection molding process is completed.

In some embodiments, the injection mold further includes an injection base 422, where the injection base 422 is disposed below the demolding module 421, and the injection base 422 is connected to the demolding module 421 by fixing bolts.

It should be noted that the C-shaped or other semi-enclosed heating meshes cannot properly adhere to the ceramic surface and tends to embed into the ceramic due to the flow of ceramic slurry, slurry pressure, and poor mold fixation. In addition, when the heating mesh is embedded into the ceramic, the heating performance of the ceramic heating core will be affected, leading to rapid carbon deposition and a burnt smell during vaporization, reduced vapor output, and poor vaporization effects.

An example of ceramic slurry injection molding for a semi-enclosed heating mesh using a hot-pressing injection mold provided in this embodiment is described below:

in this example, the heating mesh is fitted onto the injection molding fitting surface of the limiting post, the pins of the heating mesh is arranged in the receiving gap and the C-shaped opening facing downward, the injection molding slurry is injected from the injection gate 411 and flows through the injection runner into the molding cavity 414; after being subjected to the pressure from the injection molding slurry, the heating mesh is tightly pressed against the limiting post, and fixed in the receiving gap through the pins, such that the requirements for mesh fitting on both sides of the heating mesh are satisfied. In addition, the mesh sheet on either side of the heating mesh has a smaller area, and is almost not subjected to the pressure from the slurry, but is tightly pressed against the limiting post by the pins. Therefore, after injection molding, a vaporizing core as shown in FIG. 11 is obtained.

The mesh sheets of the heating mesh of the vaporizing core after injection molding tightly adhere to the inner surface of, without embedding into the ceramic. The vaporizing core prepared by this method exhibits excellent heating performance, long service life, and avoids carbon deposition and other problems.

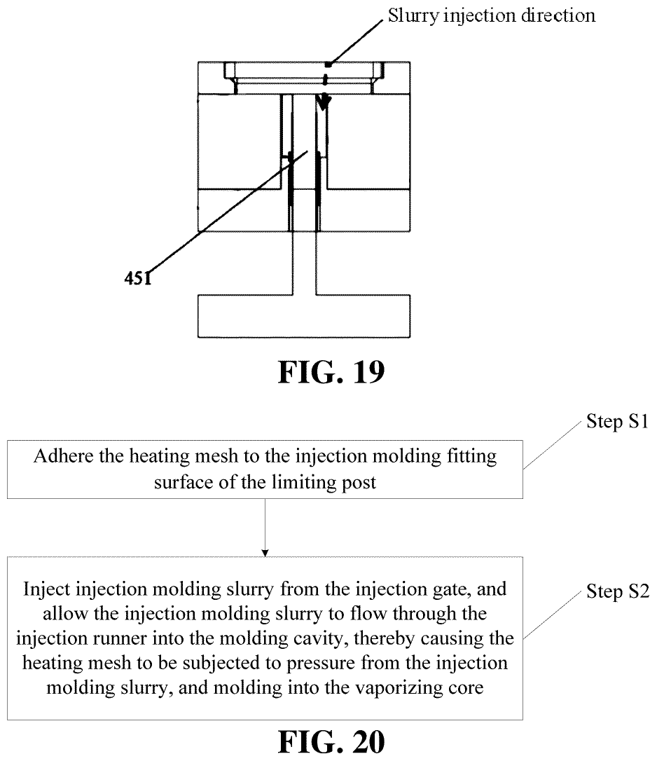

By contrast, a structure of a traditional injection mold is shown in FIG. 19, where the limiting post 451 is vertically arranged, the mesh sheets are inserted into a circular hole in a lower demolding part through pins of a cylindrical heating mesh, no fixed support is available in an upper part, therefore, the heating mesh cannot be tightly fitted onto the limiting post under the influence of external force. Moreover, when the slurry is injected in from above, the heating mesh will be pushed away from the limiting post due to pressure, resulting in further loosening. The heating mesh is embedded inside the ceramic due to the above two factors, resulting in severe carbon deposition and reduced vapor outlet during vaporization. A comparison of parameters of vaporizing cores injection molded by the traditional injection mold and the injection mold provided by this embodiment is shown in Table 1.

TABLE 1

| | | | | Vapor | | |
|---|---|---|---|---|---|---|
| | | | | output | | E-liquid |
| | | Adherence | Production | (Total | | vapor |
| | | degree | consistency | particle | | output |
| | | (Comprehensive | (Pass rate | mass | Vaporization | (No |
| | Embedding | evaluation of | per | of 10 | taste (Full | change |
| | ratio | 100 PCS) | 100PCS) | puffs) | score is 10) | in taste) |
| Examples | <5% | Good | 98% | 20 mg | 10 | 5 ml |
| Comparative | <40% | Bad | 65% | 13 mg | 7 | 2 ml |
| Example | | | | | | |

As can be seen from Table 1, the parameters of the vaporizing core prepared by the injection mold provided in this embodiment are superior to those of the vaporizing core prepared by the traditional injection mold. In addition, the vaporizing core provided in this embodiment increases the e-liquid vapor output and exhibits better vaporization performance, thereby enhancing the vaporization taste.

It should be noted that the injection mold for a vaporizing core provided in the third embodiment of the present disclosure places the heating mesh on the injection molding fitting surface of the limiting post, the injection molding slurry is injected from the injection gate and flows through the injection runner into the molding cavity. Since the limiting post is horizontally disposed inside the molding cavity, the heating mesh is pressed more tightly against the limiting post under pressure, such that the semi-enclosed heating mesh can be hot-pressed and injection-molded using a mold, solving the problems that the heating mesh cannot properly adhere to the ceramic surface and tends to embed into the ceramic due to the flow of ceramic slurry, slurry pressure, and poor mold fixation.

Based on the same inventive concept of the injection mold for a vaporizing core provided in the third embodiment, a fourth embodiment of the present disclosure further provides an injection molding method for a vaporizing core, as shown in FIG. 20. The injection molding method for a vaporizing core provided in the fourth embodiment uses the injection mold for a vaporizing core described in the third embodiment, including:
step S1. adhering the heating mesh to the injection molding fitting surface of the limiting post;
step S2: injecting injection molding slurry from the injection gate, allowing the injection molding slurry to flow through the injection runner into the molding cavity, causing the heating mesh to be subjected to pressure from the injection molding slurry, and molding into the vaporizing core as described in the second embodiment.

It should be noted that in order to ensure that the heating mesh fits more closely to the limiting post during the injection molding process, the C-shaped semi-enclosed heating mesh is fitted onto the injection molding fitting surface, a C-shaped opening of the heating mesh of the C-shaped semi-enclosed structure is formed downward, such that most of the surface of the heating mesh is subjected to a pressure of the slurry, mesh sheets of the heating mesh fit tightly against an outer surface of the limiting post without embedding into the slurry. A mesh sheet on either side of the heating mesh has a smaller area, and is almost not subjected to the pressure from the slurry, but is tightly pressed against the limiting post by the pins.

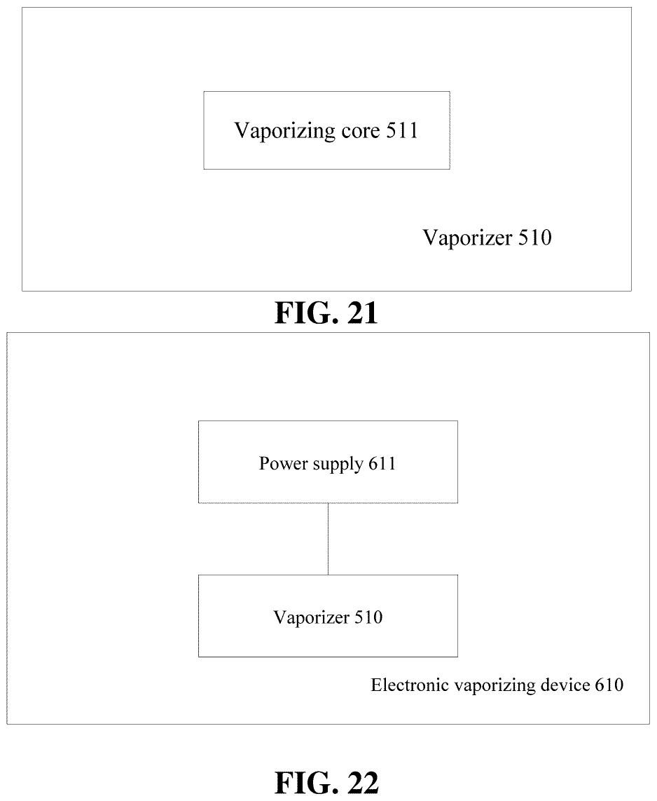

As shown in FIG. 21, a fifth embodiment of the present disclosure further provides a vaporizer 510, including the vaporizing core 511 described in the second embodiment.

As shown in FIG. 22, a sixth embodiment of the present disclosure further provides an electronic vaporizing device 610, including the vaporizer 510 as described in the fifth embodiment and a power supply 611, and the power supply 611 is electrically connected to the vaporizer 510 to supply power to the vaporizer 510.

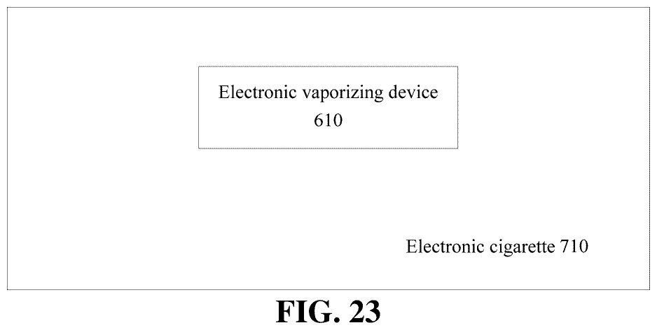

As shown in FIG. 23, a seventh embodiment of the present disclosure further provides an electronic cigarette 710, where the electronic cigarette 710 includes the electronic vaporizing device 610 as described in the sixth embodiment.

It should be noted that the vaporizer 510, the electronic vaporizing device 610, and the electronic cigarette 710 mentioned above all use the vaporizing core 511 as described in the second embodiment. Therefore, the specific limitations can refer to the limitation of the vaporizing core as described in the second embodiment, which is not repeated herein.

In the description of the present disclosure, it should be noted that orientations or positional relations indicated by the terms “upper”, “lower”, “inside”, “outside”, “top/bottom end”, etc. are based on the orientations or positional relations shown in the accompanying drawings and are only for facilitating the description of the present disclosure and simplifying the description, rather than indicating or implying that a device or element referred to must have a particular orientation or be constructed and operated in a particular orientation, and therefore will not be interpreted as limiting the present disclosure. In addition, the terms “first” and “second” are for descriptive purposes only and should not be construed as indicating or implying relative importance.

In the description of the present disclosure, it should be noted that, unless otherwise explicitly specified and defined, the terms “mounted”, “arranged”, “sleeved on/over”, “connected”, etc. should be understood in a broad sense, for example, they may be a fixed connection, a detachable connection, or an integrated connection; and may be a direct connection, or an indirect connection via an intermediate medium, or communication inside two elements. For those of ordinarily skilled in the art, specific meanings of the above terms in the present disclosure could be understood according to specific circumstances.

The above embodiments are merely intended to illustrate the technical solution of the present disclosure, but not to limit the same; although the present disclosure has been described in detail with reference to the foregoing embodiments, it should be understood by those of ordinary skill in the art that the technical solutions described in the foregoing embodiments may be modified or equivalents may be substituted for some of the technical features thereof; and the modification or substitution does not make the essence of the corresponding technical solution deviate from the spirit and the scope of the technical solution of each embodiment of the present disclosure.

1. A heating mesh, comprising:
a heating mesh body, wherein the heating mesh body is a mesh structure; and
the heating mesh body is formed into a non-enclosed structure by bending.

2. The heating mesh according to claim 1, further comprising:
an outer frame and a connecting portion, wherein the outer frame is connected to the heating mesh body via the connecting portion.

3. The heating mesh according to claim 2, wherein a breaking point is formed at a connection position between the connecting portion and the heating mesh body.

4. The heating mesh according to claim 3, wherein the breaking point is an etched breaking point.

5. The heating mesh according to claim 1, wherein a bent part of the heating mesh body is rectangular or arc-shaped.

6. (canceled)

7. (canceled)

8. (canceled)

9. (canceled)

10. (canceled)

11. (canceled)

12. (canceled)

13. (canceled)

14. (canceled)

15. A vaporizing core, comprising a porous body and the heating mesh according to claim 1; wherein
the porous body is provided with a vaporizing chamber having a square chamber structure,
the heating mesh is embedded in an inner wall of the vaporizing chamber, and an end of the porous body near a vapor outlet is provided with a ring-shaped vapor duct structure.

16. The vaporizing core according to claim 15, wherein the porous body is of a porous structure.

17. The vaporizing core according to claim 15, wherein an external structure of the porous body is cylindrical.

18. The vaporizing core according to claim 15, wherein the vaporizing chamber is connected to and integrally formed with the ring-shaped vapor duct structure.

19. The vaporizing core according to claim 15, wherein a surface of the ring-shaped vapor duct structure connected to the vaporizing chamber is a concave-convex surface.

20. The vaporizing core according to claim 15, wherein a diameter of the ring-shaped vapor duct structure is smaller than a cross-sectional width of the vaporizing chamber.

21. The vaporizing core according to claim 15, wherein at least three surfaces of the inner wall of the vaporizing chamber are provided with the heating meshes.

22. (canceled)

23. (canceled)

24. (canceled)

25. (canceled)

26. (canceled)

27. (canceled)

28. (canceled)

29. (canceled)

30. (canceled)

31. An electronic vaporizing device, comprising the vaporizing core according to claim 15 and a power supply, wherein the power supply is electrically connected to the vaporizing core to supply power to the vaporizing core.

32. (canceled)
